(19) United States
(12) Patent Application Publication
(10) Pub. No.: US 2010/0118559 A1
(43) Pub. Date: May 13, 2010

(54) VEHICULAR LAMP UNIT AND VEHICULAR LAMP

(75) Inventor: Yusuke Nakada, Shizuoka-shi (JP)

Correspondence Address: OSHA LIANG L.L.P., TWO HOUSTON CENTER, 909 FANNIN, SUITE 3500, HOUSTON, TX, 77010, US

(73) Assignee: KOITO MANUFACTURING CO., LTD., Tokyo (JP)

(21) Appl. No.: 12/615,804

(22) Filed: Nov. 10, 2009

(30) Foreign Application Priority Data
Nov. 12, 2008 (JP) 2008-289412

(51) Int. Cl. B60Q 1/00; H01J 9/00

(52) U.S. Cl. 362/539; 445/23

(57) ABSTRACT

A vehicular lamp unit includes a projection lens disposed on an optical axis extending in a vehicular longitudinal direction; a light source disposed rearward of a rear side focal point of the projection lens; a reflector for reflecting direct light from the light source forward towards the optical axis; an additional reflector disposed between the projection lens and the light source; and a shade portion disposed on the front end edge of the upper surface of the additional reflector. The additional reflector includes a flat upper surface extending rearward along the optical axis from a front end edge positioned in the vicinity of the rear side focal point of the projection lens that reflects a part of the reflected light from the reflector towards the projection lens. The shade portion forms a cut-off line of a light distribution pattern by blocking a part of the reflected light from the reflector and a part of the direct light from the light source.

### BACKGROUND OF INVENTION

1. Field of the Invention

The present invention relates to a vehicular lamp unit and a vehicular lamp of so-called projector-type, and, more particularly, relates to a vehicular lamp unit and a vehicular lamp provided with an additional reflector that forms a cut-off line of a light distribution pattern.

2. Related Art

Conventionally, as one form of a vehicular lamp, such as a headlamp, a so-called projector-type vehicular lamp is known. This projector-type vehicular lamp is structured to collect and reflect light from a light source disposed on an optical axis to the front towards the optical axis using a reflector, and to radiate the reflected light to the front of the lamp via a projection lens provided in front of the reflector.

The conventional projector-type vehicular lamp uses, as the light source, a discharging light source of a discharge bulb, a filament of a halogen bulb, or the like. However, because the light source has a certain size as a line segment light source, the reflector also has to have a certain size. Thus, it is difficult to realize a large reduction in overall size of the lamp unit.

Accordingly, there has been proposed a vehicular lamp in which an LED (light-emitting diode), which is a small-sized light source, is used. However, there has been a problem that, in a lamp which uses an LED as a light source, it is hard to obtain a light distribution pattern with sufficient luminous intensity as compared to a lamp that uses the same number of discharge bulbs, halogen bulbs, or the like as the number of the LEDs used.

A headlamp unit (lamp unit) described in Patent Document 1 is an example of a lamp unit designed to solve the problem above. The headlamp unit is structured such that a second reflective surface (upper surface) is formed on a sub-reflector provided to form a light distribution pattern having a cut-off line by blocking a part of reflected light from a first reflective surface of a main reflector. Also, a part of the reflected light from the main reflector is reflected to a convex lens (projection lens). Therefore, the light that is blocked by the sub-reflector, and thus not used, can be effectively utilized for beam radiation. Accordingly, the headlamp is designed such that the usable luminous flux of the lamp, which uses an LED as the light source, is increased, and a light distribution pattern with sufficient luminous intensity can be obtained.

[Patent Document 1] Japanese Patent Application Laid-Open (Kokai) No. JP-A-2006-107955

### SUMMARY OF INVENTION

However, the second reflective surface of the sub-reflector in the headlamp unit of the aforementioned Patent Document 1 is formed with a center step portion formed along an optical axis of the convex lens. Further, a high-position reflective surface and a low-position reflective surface are formed on both sides of the center step portion.

Therefore, reflected light reflected by the second reflective surface does not uniformly appear on a light distribution pattern formed by the reflected light from the first reflective surface of the main reflector, and a luminescent unevenness is likely to occur. Specifically, reflected light reflected by an inclined surface of the center step portion, which inclines in a lateral direction, appears from a hot zone of the light distribution pattern to an obliquely downward direction, so that the light distribution pattern sometimes gives an uncomfortable feeling to a driver.

Accordingly, one or more embodiments of the present invention provide a vehicular lamp unit and a vehicular lamp capable of reducing a luminescent unevenness when a part of reflected light from a reflector is reflected by an upper surface of an additional reflector so as to increase a total amount of light.

One or more embodiments of the present invention relate to a vehicular lamp unit comprising: a projection lens disposed on an optical axis extending in a vehicular longitudinal direction; a light source disposed rearward of a rear side focal point of the projection lens; a reflector reflecting direct light from the light source to the front towards the optical axis; an additional reflector disposed between the projection lens and the light source, the additional reflector comprising a flat upper surface extending rearward along the optical axis from a front end edge positioned in the vicinity of the rear side focal point of the projection lens that reflects a part of the reflected light from the reflector towards the projection lens; and a shade portion disposed on the front end edge of the upper surface of the additional reflector, wherein the shade portion forms a cut-off line of a light distribution pattern by blocking a part of the reflected light from the reflector and a part of the direct light from the light source.

According to the vehicular lamp unit structured as described above, the shade portion forming the cut-off line of the light distribution pattern is disposed on the front end edge of the upper surface of the additional reflector. Further, the upper surface of the additional reflector, except the vicinity of the front end edge, is formed as a horizontal flat surface extending rearward along the optical axis.

As a result of this, almost all of the reflected light reflected by the upper surface of the additional reflector corresponds to light reflected by a simple horizontal surface, so that it is possible to reduce a luminescent unevenness of the light distribution pattern by reducing the light reflected by an inclined surface of the shade portion that inclines in a lateral direction.

Note that, in the vehicular lamp unit structured as described above, it is preferable that the shade portion have a protrusion portion formed by protruding a part of the upper surface of the additional reflector, which is formed as a horizontal surface including the optical axis, along the front end edge.

With the use of the vehicular lamp unit having such a structure, the light reflected by the upper surface of the additional reflector, which is formed as a horizontal surface including the optical axis, is emitted via a portion towards a center of the projection lens. Thus, the light is likely to converge in the vicinity of the cut-off line on the light distribution pattern. Accordingly, it is possible to improve a distance visibility by making a hot zone of the light distribution pattern provided by the additional reflector appear in the vicinity of the cut-off line.

Further, one or more embodiments of the present invention relate to a vehicular lamp characterized in that an entire light distribution pattern is formed by combining a light distribution from the vehicular lamp unit structured as described above and a light distribution from another vehicular lamp unit having a light collecting power lower than a light collecting power of the above vehicular lamp unit.

With the use of the vehicular lamp structured as above, when light distributions from a plurality of lamp units are combined to form an entire light distribution pattern, by forming the upper surface of the additional reflector in the light collecting-type lamp unit having a light collecting power higher than that of another vehicular lamp unit as a horizontal surface including the optical axis, it is possible to improve the distance visibility by making the hot zone appear in the vicinity of the cut-off line.

According to the vehicular lamp unit according to one or more embodiments of the present invention, the upper surface of the additional reflector, except the front end edge, is formed as a horizontal flat surface extending rearward along the optical axis, and almost all of the reflected light reflected by the upper surface of the additional reflector corresponds to the light reflected by a simple horizontal surface.

Therefore, by reducing the light reflected by the inclined surface of the shade portion, which inclines in a lateral direction, to reduce the luminescent unevenness of the light distribution pattern, it is possible to reduce an uncomfortable feeling given to a driver by the light distribution pattern.

Other aspects and advantages of the invention will be apparent from the following description, the drawings and the claims.

### BRIEF DESCRIPTION OF DRAWINGS

FIG. 1 is a horizontal cross-sectional view of a vehicular lamp according to one or more embodiments of the present invention.

FIG. 2 is a sectional view along the line II-II in FIG. 1.

FIG. 3 is a longitudinal sectional view that explains a basic structure of a lamp unit shown in FIG. 2.

FIG. 4 is an enlarged sectional view of a substantial part of the lamp unit shown in FIG. 3.

FIG. 5 is an upper perspective view of an additional reflector shown in FIG. 2.

FIG. 6 is a view that shows, in a perspective manner, a low-beam light distribution pattern formed on a virtual vertical screen disposed at a position 25 meters (m) ahead of the lamp by light radiated from the lamp unit shown in FIG. 2.

FIG. 7 is an upper perspective view of an additional reflector showing a modified example of the additional reflector shown in FIG. 2.

### DETAILED DESCRIPTION

Hereafter, embodiments of a vehicular lamp unit and a vehicular lamp according to the present invention will be described in detail with reference to accompanying drawings.

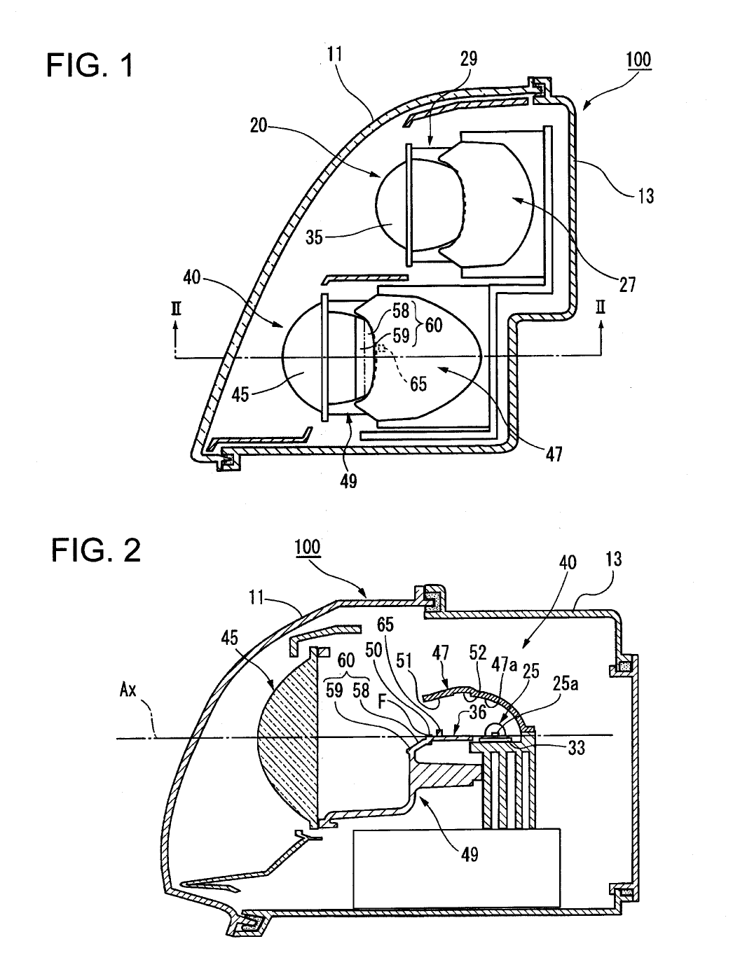

FIG. 1 is a horizontal cross-sectional view of a vehicular lamp according to one or more embodiments of the present invention.

A vehicular lamp 100 is a low-beam headlamp, and is structured such that, in a lamp chamber formed of a plain translucent cover 11 and a lamp body 13, a plurality of (two, in the embodiment shown) lamp units are housed side-by-side. The lamp units are formed of a lamp unit (vehicular lamp unit) 40 having a high light collecting power and another lamp unit (another vehicular lamp unit) 20 having a light collecting power lower than that of the lamp unit 40.

These lamp units 20, 40 are supported in the lamp body 13 via a frame (not shown), and the frame is supported in the lamp body 13 via an aiming mechanism (not shown).

The aiming mechanism is a mechanism for finely adjusting attachment positions and attachment angles of these lamp units 20, 40. When the aiming adjustment is completed, a lens central axis Ax of each of the lamp units 20, 40 extends in a downward direction by about 0.5 to 0.6 degrees relative to a vehicular longitudinal direction.

As will be described later, the lamp unit 20 forms a diffusion zone formation pattern WZ having horizontal and oblique cut-off lines on an upper end edge thereof. The lamp unit 40 forms a hot zone formation pattern HZ having horizontal and oblique cut-off lines on an upper end edge thereof.

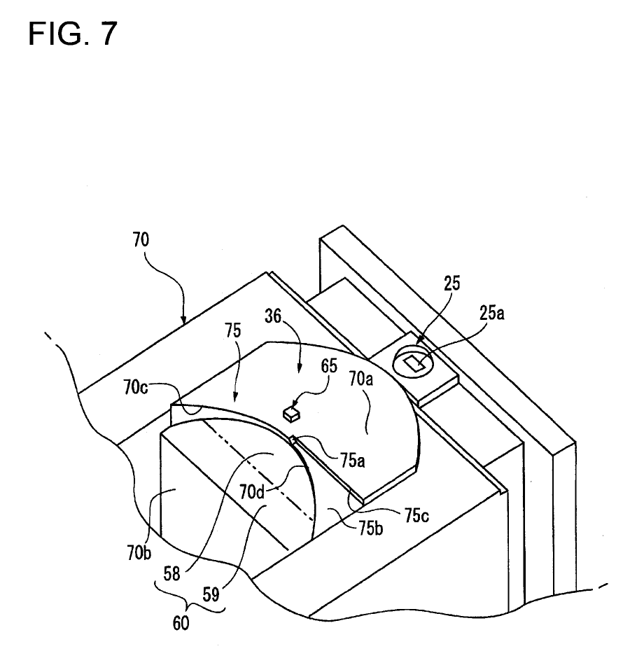

Specifically, a low-beam light distribution pattern PL formed by the vehicular lamp 100 is designed to be formed as a combined light distribution pattern of the diffusion zone formation pattern WZ and the hot zone formation pattern HZ formed by these two lamp units 20, 40 (refer to FIG. 6).

These lamp units 20, 40, which serve as low-beam light distribution pattern forming units, are structured as projector-type lamp units each formed of a light source and a projection lens provided on a front side of the light source, as will be described later.

Hereinafter, a concrete structure of each of the lamp units 20, 40 will be described.

First, a structure of the lamp unit 40 will be described.

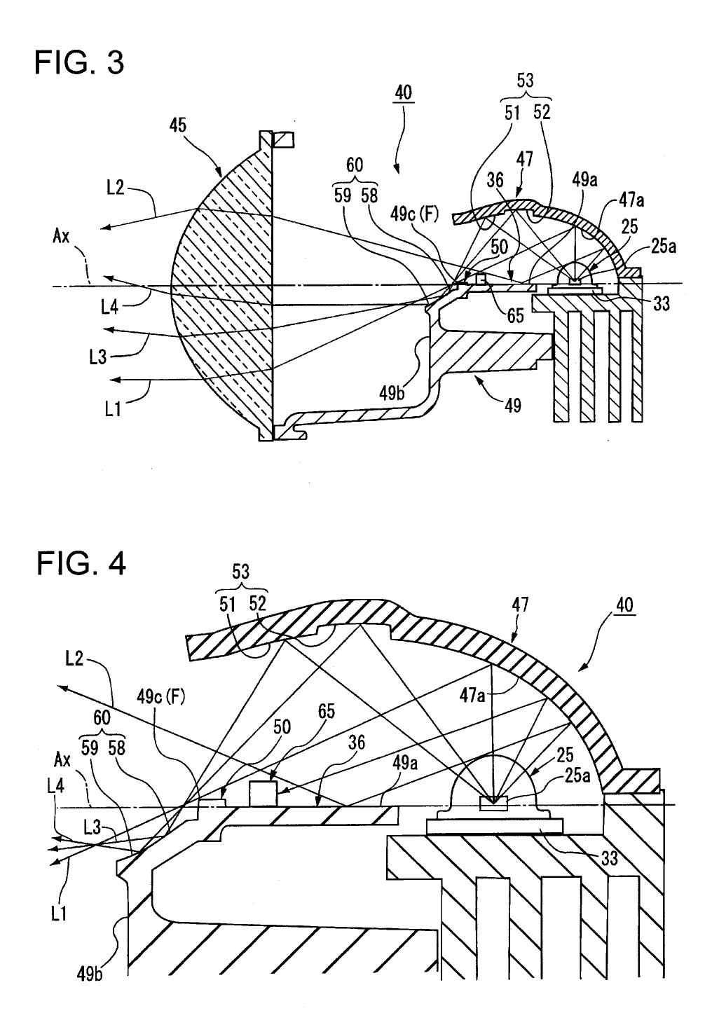

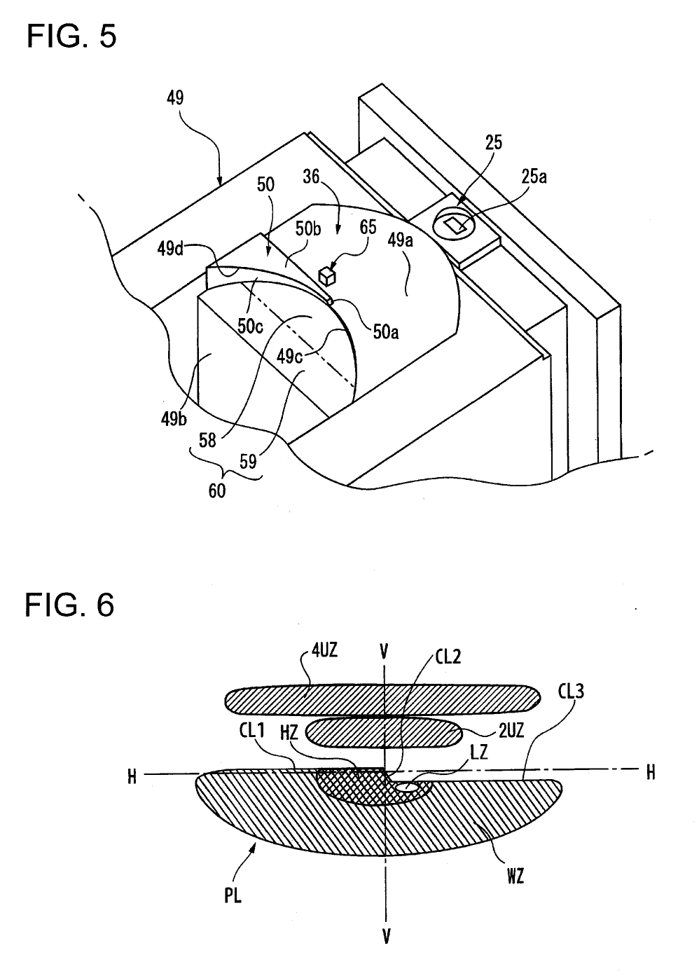

FIG. 2 is a sectional view along the line II-II in FIG. 1, FIG. 3 is a longitudinal sectional view that explains a basic structure of a lamp unit shown in FIG. 2, FIG. 4 is an enlarged sectional view of a substantial part of the lamp unit shown in FIG. 3, FIG. 5 is an upper perspective view of an additional reflector shown in FIG. 2, and FIG. 6 is a view that shows, in a perspective manner, a low-beam light distribution pattern formed on a virtual vertical screen disposed at a position 25 meters (m) ahead of the lamp by light radiated from the lamp unit shown in FIG. 2.

As shown in FIG. 2, the lamp unit 40 includes: a projection lens 45 disposed on an optical axis Ax extending in a vehicular longitudinal direction; an LED (light-emitting diode) 25, which is used as a light source, disposed rearward of a rear side focal point F of the projection lens 45; a reflector 47 that reflects direct light from the LED 25 to the front towards the optical axis Ax; an additional reflector 49 disposed between the projection lens 45 and the LED 25, wherein the additional reflector 49 has flat upper surface 49a extending rearward along the optical axis Ax from a front end edge 49c positioned in the vicinity of the rear side focal point F of the projection lens 45 that reflects a part of reflected light from the reflector 47 towards the projection lens 45; and a shade portion 50 disposed on the front end edge 49c of the upper surface 49a of the additional reflector 49, wherein the shade portion forms a cut-off line of a light distribution pattern by blocking a part of the reflected light from the reflector 47 and a part of the direct light from the LED 25.

The LED 25 is a white light-emitting diode having a single light-emitting chip 25a whose size is about 1 millimeter (mm) square, for instance. The LED 25 is disposed rearward of the rear side focal point F of the projection lens 45, and directed upward in the vertical direction on the optical axis Ax in the state where the LED 25 is supported by a substrate 33.

As shown in FIG. 3 and FIG. 4, the reflector 47 is a generally dome-shaped member provided on an upper side of the LED 25. The reflector 47 has a reflective surface 47a that collects and reflects light L1 from the LED 25 to the front towards the optical axis Ax.

The reflective surface 47a is formed in a shape of ellipsoidal reflective surface, in which the optical axis Ax is set as a central axis. Specifically, the reflective surface 47a has a vertical cross-section including the optical axis Ax that is set to be a generally ellipsoidal shape, and an eccentricity thereof is set to gradually increase from the vertical cross-section to a horizontal cross-section.

However, rear-side vertices of ellipses forming the respective cross-sections are set at the same position. The LED 25 is disposed on a first focal point of the ellipse forming the vertical cross-section of the reflective surface 47a. Accordingly, the reflective surface 47a collects and reflects the light L1 from the LED 25 to the front towards the optical axis Ax, and, at that time, the light is generally converged on a second focal point of the ellipse on the vertical cross-section including the optical axis Ax.

Further, a first reflective surface 53 that reflects a part of the direct light from the LED 25 downward to the front of the additional reflector 49 is formed on a tip portion of the reflector 47, as shown in FIG. 4.

The first reflective surface 53 is formed further on a tip side of an effective reflective surface of the reflective surface 47a of the reflector 47. The first reflective surface 53 has a front-side first reflective surface 51 and a rear-side first reflective surface 52, which are divided in a longitudinal direction.

The front-side first reflective surface 51 is formed in a shape of ellipsoidal reflective surface having a vertical cross-section that is generally ellipsoidal in shape. The front-side first reflective surface 51 has a first focal point and a second focal point P that are respectively set to the LED 25 and a position above the rear-side focal point F of the projection lens 45. The front-side first reflective surface 51 reflects the light from the LED 25 towards an upper-side second reflective surface 58 of a second reflective surface 60. The second reflective surface 60 is formed on the front of the additional reflector 49, which is provided with the shade portion 50 that forms a cut-off line of a light distribution pattern for left-side light distribution, and below the rear side focal point F of the projection lens 45.

The rear-side first reflective surface 52 is formed in a shape of generally parabolic reflective surface having a vertical cross-section that is parabolic in shape. The rear-side first reflective surface 52 has a focal point that is set to the LED 25. The rear-side first reflective surface 52 reflects the light from the LED 25 towards a lower-side second reflective surface 59 of the second reflective surface 60.

The second reflective surface 60 is formed on the front of the additional reflector 49 and below the rear side focal point F of the projection lens 45. The second reflective surface 60 reflects the reflected light from the first reflective surface 53 towards the projection lens 45 so that upward directed radiated light is emitted from the projection lens 45.

Further, the second reflective surface 60 has the upper-side second reflective surface 58 and the lower-side second reflective surface 59, which are divided in a vertical direction by an imaginary line shown in FIG. 1 and FIG. 5.

Accordingly, the reflected light from the front-side first reflective surface 51 is incident on the upper-side second reflective surface 58, and the reflected light from the rear-side first reflective surface 52 is incident on the lower-side second reflective surface 59. Subsequently, the radiated light provided by the lower-side second reflective surface 59, which is formed in a shape of generally curved surface having a curved vertical cross-section, radiates above the radiated light provided by the upper-side second reflective surface 58, which is formed in a shape of generally flat surface having a linear vertical cross-section.

Note that the lower-side second reflective surface 59 is smoothly formed continuously to a lower portion of the upper-side second reflective surface 58.

Further, the lamp unit 40 is structured such that reflected light L3 reflected by the front-side first reflective surface 51 and the upper-side second reflective surface 58 radiates “4L, V, 4R” on 2U in a low-beam left-side light distribution pattern with a predetermined amount of light, and reflected light L4 reflected by the rear-side first reflective surface 52 and the lower-side second reflective surface 59 radiates “8L, V, 8R” on 4U in the pattern with a predetermined amount of light, which is a requirement imposed by a European regulation (ECE R112) (refer to FIG. 6).

Specifically, the light incident on the projection lens 45 from the upper-side second reflective surface 58 and the lower-side second reflective surface 59 is emitted as upward directed radiated light L3, L4, which radiate above the low-beam light distribution pattern PL.

Therefore, the vehicular lamp unit 40 can radiate the predetermined amount of reflected light with such a level that the light does not give a glare to a vehicle on the opposite lane, and also onto vertically divided two areas (2UZ and 4UZ) above the low-beam light distribution pattern PL. Accordingly, it is possible to improve the forward visibility by forming an optimum light distribution pattern.

The projection lens 45 is formed of a planoconvex lens that has a convex front side surface and a flat rear side surface. The projection lens 45 is disposed on the optical axis Ax so that the rear side focal point F thereof is positioned on a second focal point of the reflective surface 47a of the reflector 47, as shown in FIG. 3. Accordingly, an image on a focal plane including the rear side focal point F is set to be projected forward as an inverted image.

In one or more embodiments, the additional reflector 49 has a shape of block that also serves as a supporting frame of the projection lens 45, and is disposed between the projection lens 45 and the LED 25, as shown in FIG. 3 and FIG. 5. Further, the additional reflector 49 has the flat upper surface 49a that extends rearward from the front end edge 49c and reflects a part of the reflected light from the reflector 47 towards the projection lens 45. A light control surface 36 to which reflective surface treatment is applied is formed on the upper surface 49a.

Specifically, the additional reflector 49 is designed such that, by reflecting a part of the reflected light from the reflector 47 towards the projection lens 45 using the light control surface 36, most of the light to be emitted upward from the projection lens 45 is converted into the light L2 emitted downward from the projection lens 45, thereby enhancing a luminous flux utilization factor of the light emitted from the LED 25.

Specifically, the light control surface 36 is formed as a horizontal surface including the optical axis Ax, and the front end edge 49c (namely, an edge line between the light control surface 36 and a front end surface of the additional reflector 49) is formed so as to pass through the rear side focal point F of the projection lens 45.

Further, of the light emitted from the LED 25, a part of the light reflected by the reflective surface 47a of the reflector 47 is incident on the light control surface 36 of the additional reflector 49, and the remainder of the light is incident directly on the projection lens 45. At that time, the light incident on the light control surface 36 is incident on the projection lens 45 by being reflected upward by the light control surface 36, and the light is emitted as the downward directed light L2 from the projection lens 45.

The shade portion 50 has a protrusion portion formed by protruding a part of the upper surface 49a of the additional reflector 49 formed as a horizontal surface including the optical axis Ax (right side portion of a vehicle) along the front end edge 49c, as shown in FIG. 4 and FIG. 5.

Specifically, the protrusion portion is formed of an oblique cut-off formation surface 50a extending obliquely upward by 15° in the right direction generally from the optical axis Ax (in the left direction as shown in FIG. 5), a horizontal cut-off formation surface 50b extending horizontally in the right direction from the oblique cut-off formation surface 50a (in the left direction as shown in FIG. 5), and a front end surface 50c. A front end edge 49d (namely, an edge line between the horizontal cut-off formation surface 50b and the front end surface 50c) is formed so as to pass through the vicinity of the rear side focal point F of the projection lens 45.

Accordingly, the front end edge 49c of the additional reflector 49 is formed in a curved shape in which lateral ends thereof protrude forward in a plan view so as to correspond to a field curvature of the projection lens 45. The curved front end edge 49c coincides with a focal group of the projection lens 45. Specifically, in the additional reflector 49, the front end edge 49c of a left side portion of the vehicle and the front end edge 49d of the protrusion portion are formed along the focal group of the projection lens 45, and shapes of the front end edges 49c and 49d directly correspond to a shape of the cut-off line.

Further, the front end edge 49c and the front end edge 49d are positioned in the vicinity of the rear side focal point F of the projection lens 45 to block a part of the reflected light from the reflector 47, thereby forming a cut-off line of the left-side light distribution pattern.

Further, as shown in FIG. 4 and FIG. 5, the additional reflector 49 has a blocking portion 65 in the vicinity of the shade portion 50 of the right side portion of the vehicle on the upper surface 49a. The blocking portion 65 is formed to protrude upward from the upper surface 49a. The blocking portion 65 operates to block a part of the reflected light from the reflector 47 and a part of the reflected light from the upper surface 49a, as shown in FIG. 4.

Specifically, in the lamp unit 40 of one or more embodiments, a part of the reflected light from the reflector 47 is reflected by the upper surface 49a of the additional reflector 49, and the light to be emitted upward from the projection lens 45 is converted into the light emitted downward from the projection lens 45, thereby enhancing a luminous flux utilization factor of the light emitted from the LED 25, as shown in FIG. 3 and FIG. 4.

Further, even when the amount of light on the lower side of the cut-off line is increased as a whole as described above, because a part of the reflected light from the reflector 47 and a part of the reflected light from the upper surface 49a are blocked by the blocking portion 65, a light-reduced area LZ is formed on a part of the lower side of a cut-off line of an opposite lane side, as shown in FIG. 6.

Here, a height of the blocking portion 65 is set so that reflected light from an upper end of an effective reflective surface of the reflective surface 47a of the reflector 47 is not blocked, and, accordingly, there is no chance to break the cut-off line of the opposite lane side. Therefore, it is possible to form the light-reduced area LZ on a part of the lower side of the cut-off line of the opposite lane side, while keeping the cut-off line.

Next, the lamp unit 20 will be described.

As shown in FIG. 1, the lamp unit 20 includes a light-emitting diode (not shown) as a light source, a reflector 27, and a projection lens 35. The light-emitting diode has the same structure as that of the LED 25 of the lamp unit 40, and is disposed on an optical axis Ax and directed upward in the vertical direction.

The reflector 27 is a generally dome-shaped member provided on an upper side of the light-emitting diode. Further, the reflector 27 has a reflective surface having a shape of ellipsoidal reflective surface that diffuses and reflects light from the light-emitting diode to the front, with low light collecting power compared to that of the reflective surface 47a of the reflector 47.

The projection lens 35 is formed of a planoconvex lens that has a convex front side surface and a flat rear side surface. The projection lens 35 is disposed on the optical axis Ax so that a rear side focal point of the projection lens 35 is positioned on a second focal point of the reflective surface of the reflector 27, and accordingly, an image on a focal plane including the rear side focal point is set to be projected forward as an inverted image. Note that because the radiated light from the lamp unit 20 is only required to reach a relatively shorter distance, the projection lens 35 uses a lens whose diameter is smaller than that of the projection lens 45 of the lamp unit 40.

Further, as shown in FIG. 6, the diffusion zone formation pattern WZ formed by the lamp unit 20 is a low-beam light distribution pattern for left-hand traffic having a cut-off line CL1 of a vehicle's own lane side and a cut-off line CL3 of an opposite lane side, which extend in a horizontal direction, and an oblique cut-off line CL2, on an upper end edge of the diffusion zone formation pattern WZ.

Further, the hot zone formation pattern HZ formed by the lamp unit 40 is formed to overlap with the diffusion zone formation pattern WZ, and is a hot zone formation pattern in which a light collecting power is higher than that in the diffusion zone formation pattern WZ.

Further, a light distribution pattern 2UZ is a light distribution pattern in which the reflected light L3 reflected by the front-side first reflective surface 51 and the upper-side second reflective surface 58 radiates “4L, V, 4R” on 2U in the low-beam left-side light distribution pattern with a predetermined amount of light. Further, a light distribution pattern 4UZ is a light distribution pattern in which the reflected light L4 reflected by the rear-side first reflective surface 52 and the lower-side second reflective surface 59 radiates “8L, V, 8R” on 4U in the low-beam left-side light distribution pattern with a predetermined amount of light.

Accordingly, the diffusion zone formation pattern WZ, the hot zone formation pattern HZ, and the light distribution patterns 2UZ and 4UZ overlap in the illustrated manner, thereby forming the low-beam light distribution pattern PL of the vehicular lamp 100 as a combined light distribution pattern.

Specifically, with the use of the vehicular lamp unit 40 of the vehicular lamp 100 according to one or more embodiments, a part of the reflected light from the reflector 47 is reflected by the upper surface 49a of the additional reflector 49, and the light to be emitted upward from the projection lens 45 is converted into the light emitted downward from the projection lens 45, thereby enhancing a luminous flux utilization factor of the light emitted from the LED 25.

Further, in one or more embodiments, the shade portion 50 forming the cut-off line of the light distribution pattern is disposed on the front end edge 49c of the upper surface 49a of the additional reflector 49. Also, the upper surface 49a of the additional reflector 49, except the vicinity of the front end edge 49c, is formed as a horizontal flat surface extending rearward along the optical axis Ax.

As a result of this, almost all of the reflected light L2 reflected by the upper surface 49a of the additional reflector 49 corresponds to light reflected by a simple horizontal surface, so that it is possible to reduce a luminescent unevenness of the light distribution pattern by reducing the light reflected by the oblique cut-off formation surface (inclined surface) 50a of the shade portion 50 that inclines in a lateral direction.

Further, the shade portion 50 of the vehicular lamp unit 40 has the protrusion portion formed by protruding a part of the upper surface 49a of the additional reflector 49 formed as a horizontal surface including the optical axis Ax along the front end edge 49c.

Accordingly, the light reflected by the upper surface 49a of the additional reflector 49, which is formed as a horizontal surface including the optical axis Ax, is emitted via a portion towards a center of the projection lens 35, so that the light is likely to converge in the vicinity of the cut-off line of the hot zone formation pattern HZ. Accordingly, it is possible to improve a distance visibility by making a hot zone of the light distribution pattern provided by the additional reflector 49 appear in the vicinity of the cut-off line.

Further, the first reflective surface 53 is positioned further on the LED 25 side relative to the rear side focal point F of the projection lens 45 and is formed close to the LED 25, so that a size of the first reflective surface 53 can be reduced. Further, a light source image of the reflected light from the first reflective surface 53 close to the LED 25 becomes large, which enables weak light to be radiated over a wide range above H line.

Further, the lamp unit 40 of one or more embodiments is used as a light collecting-type lamp unit having the highest light collecting power in the vehicular lamp 100 that combines a light distribution from another lamp unit 20 having a light collecting power lower than that of the lamp unit 40 to form the entire low-beam light distribution pattern PL.

Accordingly, in case of the vehicular lamp 100 that combines the light distributions from the plurality of lamp units 20, 40 to form the entire low-beam light distribution pattern PL, by forming the upper surface 49a of the additional reflector 49 in the light collecting-type lamp unit 40 having a light collecting power higher than that of another lamp unit 20 in a horizontal surface including the optical axis Ax, it is possible to improve the distance visibility by making the hot zone appear in the vicinity of the cut-off line.

Next, a modified example of the lamp unit according to one or more embodiments will be described.

FIG. 7 is an upper perspective view of an additional reflector, which is a modified example of the additional reflector shown in FIG. 2. Note that constituent portions that are generally the same as those of the additional reflector 49 of the aforementioned embodiments are denoted by the same reference numerals, and a detailed explanation thereof will be omitted.

An additional reflector 70 of the example shown in FIG. 7 is designed such that, similar to the additional reflector 49 of the aforementioned embodiments, by reflecting a part of the reflected light from the reflector 47 to the projection lens 45 using the light control surface 36, most of the light is converted to be emitted upward from the projection lens 45 into the light L2 emitted downward from the projection lens 45, thereby enhancing a luminous flux utilization factor of the light emitted from the LED 25.

A shade portion 75 of the additional reflector 70 has a caved portion formed by caving a part of an upper surface 70a of the additional reflector 70 formed as a horizontal surface parallel to the optical axis Ax (left side portion of a vehicle) along a front end edge 70c.

Specifically, the caved portion is formed of an oblique cut-off formation surface 75a extending obliquely upward by 15° in the right direction generally from the optical axis Ax (in the left direction in FIG. 7), a horizontal cut-off formation surface 75b extending horizontally in the left direction generally from the optical axis Ax (in the right direction in FIG. 7), and a front end surface 75c. A front end edge 70d is formed so as to pass through the rear side focal point F of the projection lens 45.

The front end edge 70c of the additional reflector 70 is formed in a curved shape in which lateral ends thereof protrude forward in a plan view so as to correspond to a field curvature of the projection lens 45. The curved front end edge 70c coincides with a focal group of the projection lens 45. Specifically, in the additional reflector 70, the front end edge 70c of a right side portion of the vehicle and the front end edge 70d of the caved portion are formed along the focal group of the projection lens 45, and the shapes of the front end edges 70c and 70d directly correspond to the shape of the cut-off line.

Further, the front end edge 70c and the front end edge 70d are positioned in the vicinity of the rear side focal point F of the projection lens 45 to block a part of the reflected light from the reflector 47, thereby forming a cut-off line of a left-side light distribution pattern.

Further, the additional reflector 70 has a blocking portion 65 in the vicinity of the shade portion 75 of the right side portion of the vehicle on the upper surface 70a. The blocking portion 65 is formed to protrude upward from the upper surface 70a. The blocking portion 65 operates to block a part of the reflected light from the reflector 47 and a part of the reflected light from the upper surface 70a.

Specifically, the shade portion 75 forming the cut-off line of the light distribution pattern is disposed on the front end edge 70c of the upper surface 70a of the additional reflector 70. Also, the upper surface 70a of the additional reflector 70, except the vicinity of the front end edge 70c, is formed as a horizontal flat surface extending rearward, in parallel with the optical axis Ax, spaced slightly above the optical axis Ax.

As a result of this, almost all of the reflected light L2 reflected by the upper surface 70a of the additional reflector 70 corresponds to light reflected by a simple horizontal surface, so that it is possible to reduce a luminescent unevenness of the light distribution pattern by reducing the light reflected by the oblique cut-off formation surface (inclined surface) 75a of the shade portion 75 that inclines in a lateral direction.

Those skilled in the art will appreciate the vehicular lamp unit and the vehicular lamp of the present invention may be varied in many ways within the spirit of the present invention.

For instance, although the vehicular lamp 100 of the aforementioned embodiments is structured such that the plurality of lamp units are housed side-by-side in the lamp chamber. The present invention is not limited to this, and a single lamp unit may be used. Further, the light source is not limited to a semiconductor light-emitting element such as a light-emitting diode. Rather, a discharge bulb such as a metal halide bulb and a halogen bulb may also be used.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF THE REFERENCE NUMERALS

20 LAMP UNIT (ANOTHER VEHICULAR LAMP UNIT)
25 LED (LIGHT SOURCE)
36 LIGHT CONTROL SURFACE
40 LAMP UNIT (VEHICULAR LAMP UNIT)
45 PROJECTION LENS
47 REFLECTOR
49 ADDITIONAL REFLECTOR
49a UPPER SURFACE
49c FRONT END EDGE
50 SHADE PORTION
50a OBLIQUE CUT-OFF FORMATION SURFACE
50b HORIZONTAL CUT-OFF FORMATION SURFACE
50c FRONT END SURFACE
51 FRONT-SIDE FIRST REFLECTIVE SURFACE
52 REAR-SIDE FIRST REFLECTIVE SURFACE
53 FIRST REFLECTIVE SURFACE
58 UPPER-SIDE SECOND REFLECTIVE SURFACE
59 LOWER-SIDE SECOND REFLECTIVE SURFACE
60 SECOND REFLECTIVE SURFACE
65 BLOCKING PORTION
100 VEHICULAR LAMP
Ax OPTICAL AXIS
CL CUT-OFF LINE
CL1 CUT-OFF LINE OF VEHICLE'S OWN LANE SIDE
CL2 OBLIQUE CUT-OFF LINE
CL3 CUT-OFF LINE OF OPPOSITE LANE SIDE
F REAR-SIDE FOCAL POINT

What is claimed is:

1. A vehicular lamp unit comprising:
a projection lens disposed on an optical axis extending in a vehicular longitudinal direction;
a light source disposed rearward of a rear side focal point of the projection lens;
a reflector for reflecting direct light from the light source forward towards the optical axis;
an additional reflector disposed between the projection lens and the light source, the additional reflector comprising a flat upper surface extending rearward along the optical axis from a front end edge positioned in the vicinity of the rear side focal point of the projection lens that reflects a part of the reflected light from the reflector towards the projection lens; and
a shade portion disposed on the front end edge of the upper surface of the additional reflector,
wherein the shade portion forms a cut-off line of a light distribution pattern by blocking a part of the reflected light from the reflector and a part of the direct light from the light source.

2. The vehicular lamp unit according to claim 1,
wherein the shade portion comprises a protrusion portion formed by protruding a part of the upper surface of the additional reflector formed as a horizontal surface including the optical axis along the front end edge.

3. A vehicular lamp wherein an entire light distribution pattern is formed by combining a light distribution from the vehicular lamp unit according to claim 1 and a light distribution from another vehicular lamp unit having a light collecting power lower than a light collecting power of the vehicular lamp unit.

4. A vehicular lamp wherein an entire light distribution pattern is formed by combining a light distribution from the vehicular lamp unit according to claim 2 and a light distribution from another vehicular lamp unit having a light collecting power lower than a light collecting power of the vehicular lamp unit.

5. The vehicle lamp according to claim 1,
wherein the reflector comprises a first reflective surface formed on a tip side of the reflector,
wherein the first reflective surface comprises a front-side first reflective surface and a rear-side first reflective surface, and
wherein the front-side first reflective surface and the rear-side first reflective surface are divided in a longitudinal direction.

6. The vehicle lamp according to claim 5,
wherein the front-side first reflective surface is formed in a shape of ellipsoidal reflective surface having a vertical cross-section that is generally ellipsoidal in shape, and
wherein the rear-side first reflective surface formed in a shape of generally parabolic reflective surface having a vertical cross-section that is parabolic in shape.

7. The vehicle lamp according to claim 5,
wherein the additional reflector comprises a second reflective surface comprising an upper-side second reflective surface and a lower-side second reflective surface, and
wherein the upper-side second reflective surface and a lower-side second reflective surface are divided in a vertical direction.

8. The vehicle lamp according to claim 7, wherein the lower-side second reflective surface is smoothly formed continuously to a lower portion of the upper-side second reflective surface.

9. The vehicle lamp according to claim 8,
wherein the lower-side second reflective surface is formed in a shape of generally curved surface having a curved vertical cross-section, and
wherein the upper-side second reflective surface is formed in a shape of generally flat surface having a linear vertical cross-section.

10. The vehicle lamp according to claim 9,
wherein the front-side first reflective surface reflects the light from the light source towards the upper-side second reflective surface,
wherein the rear-side first reflective surface reflects the light from the light source towards a lower-side second reflective surface, and
wherein the upper-side second reflective surface and lower-side second reflective surface reflect the light reflected from the first reflective surface towards the projection lens so that upward directed radiated light is emitted from the projection lens.

11. The vehicle lamp according to claim 10, wherein the radiated light provided by the lower-side second reflective surface radiates above the radiated light provided by the upper-side second reflective surface.

12. The vehicle lamp according to claim 3,
wherein the reflector comprises a first reflective surface formed on a tip side of the reflector,
wherein the first reflective surface comprises a front-side first reflective surface and a rear-side first reflective surface,
wherein the front-side first reflective surface and the rear-side first reflective surface are divided in a longitudinal direction,
wherein the additional reflector comprises a second reflective surface comprising an upper-side second reflective surface and a lower-side second reflective surface, and
wherein the upper-side second reflective surface and the lower-side second reflective surface are divided in a vertical direction.

13. The vehicle lamp according to claim 12,
wherein the front-side first reflective surface is formed in a shape of ellipsoidal reflective surface having a vertical cross-section that is generally ellipsoidal in shape,
wherein the rear-side first reflective surface formed in a shape of generally parabolic reflective surface having a vertical cross-section that is parabolic in shape,
wherein the lower-side second reflective surface is formed in a shape of generally curved surface having a curved vertical cross-section, and
wherein the upper-side second reflective surface is formed in a shape of generally flat surface having a linear vertical cross-section.

14. The vehicle lamp according to claim 13, wherein the lower-side second reflective surface is smoothly formed continuously to a lower portion of the upper-side second reflective surface.

15. The vehicle lamp according to claim 14,
wherein the front-side first reflective surface reflects the light from the light source towards the upper-side second reflective surface,
wherein the rear-side first reflective surface reflects the light from the light source towards a lower-side second reflective surface, and
wherein the upper-side second reflective surface and lower-side second reflective surface reflect the light reflected from the first reflective surface towards the projection lens so that upward directed radiated light is emitted from the projection lens.

16. The vehicle lamp according to claim 15, wherein the radiated light provided by the lower-side second reflective surface radiates above the radiated light provided by the upper-side second reflective surface.

17. A method of manufacturing a vehicular lamp unit comprising:
disposing a projection lens on an optical axis extending in a vehicular longitudinal direction;
disposing a light source rearward of a rear side focal point of the projection lens;
arranging a reflector to reflect direct light from the light source forward towards the optical axis;
disposing an additional reflector between the projection lens and the light source, the additional reflector comprising a flat upper surface extending rearward along the optical axis from a front end edge positioned in the vicinity of the rear side focal point of the projection lens that reflects a part of the reflected light from the reflector towards the projection lens; and
disposing a shade portion on the front end edge of the upper surface of the additional reflector such that the shade portion forms a cut-off line of a light distribution pattern by blocking a part of the reflected light from the reflector and a part of the direct light from the light source.

18. The method according to claim 17 further comprising:
forming a protrusion portion in the shade portion by protruding a part of the upper surface of the additional reflector formed as a horizontal surface including the optical axis along the front end edge.

19. The method according to claim 17 further comprising:
forming an entire light distribution pattern by combining a light distribution from the vehicular lamp unit manufactured according to claim 18, and a light distribution from another vehicular lamp unit having a light collecting power lower than a light collecting power of the vehicular lamp unit.
